(19) United States
(12) Patent Application Publication
(10) Pub. No.: US 2005/0197054 A1
(43) Pub. Date: Sep. 8, 2005

(54) Coin wrapper for rapid insertion into a coin-filled coin counting tube

(76) Inventor: Burr V. Deitz, Albany, NY (US)

Correspondence Address: BURR V. DEITZ, 444 Whitehall Rd., ALBANY, NY, 12208, US

(21) Appl. No.: 10/791,614

(22) Filed: Mar. 3, 2004

(51) Int. Cl. G07D 9/06; G07D 9/04

(52) U.S. Cl. 453/61

(57) ABSTRACT

A coin wrapper for rapid and facile insertion into a coin-filled coin counting tube. The receiving end of the coin wrapper may resemble the point of a new spade-pointed garden shovel, or the worn-down point of an old garden shovel. The leading edge of the of the receiving end may be an ellipse, or a more complex shape including at least one protrusion (point) that is deeper than one thickness of one of the coins to be wrapped therein. The article of the present invention is useful for packaging a stack of coins contained within a coin counting tube, and for packaging coins without the necessity of fighting resistance to the insertion of a coin wrapper presented by a plurality of stacked coins, and for reducing the dexterity required on the part of the person wrapping such coins to package them.

### BACKGROUND OF THE INVENTION

1. Field of the Invention

The present invention relates to coin wrapping for packaging of coins. More particularly, a tubular paper coin wrapper adapted for rapid insertion into a coin-filled coin counting tube.

2. Description of the Related Art

U.S. Pat. No. 2,554,713, issued in 1947 describes a conventional paper coin wrapper of the type still in use today as being “a conventional paper wrapper now in common use.” The conventional tubular coin wrapper remains virtually unchanged since 1947 in terms of shape and function, although today some wrappers are made of materials other than paper, such as plastic.

FIG. 1 is an isometric view of a conventional coin wrapper 100 having an open receiving end 110 and a sealed or crimped end 120. The conventional coin wrapper 100 has the general form of a right circular cylinder. The edge 111 of the receiving end 110 of the conventional coin wrapper 100 is substantially circular, being in a planar section of the tubular (cylindrical) coin wrapper 100 that lies in a plane perpendicular to the geometrical axis of the tubular (cylindrical) coin wrapper 100.

A “flattened” conventional (paper) coin wrapper is approximately a right circular cylinder that is substantially compressed in a dimension perpendicular to its axis and has the general form of a rectangle but has a first layer and a second layer that are joined along each of two folds that are substantially parallel with the original geometrical axis of the cylindrical coin wrapper. Paper coin wrappers are often sold in a “flattened” condition, to be expanded into the general shape of a tube (cylinder) by an end user. Vendors of such flattened conventional (paper) coin wrappers, called Flat Tubular Coin Wrappers, teach that they will “pop open [to a cylindrical form as in FIG. 100] with just a squeeze for ease of use.”

FIG. 2A and FIG. 2B are diagrams illustrating the geometry of a circular cylinder 200 having a first (circular) cylindrical section 220 at one (bottom) end and a second (elliptical) cylindrical section 210 at the opposite (bottom) end.

The intersection of a plane (a planar cut) with a right circular cylinder is called a cylindrical section. The intersection of a plane with a right circular cylinder (cylindrical section) is a circle (if the plane is at a right angle to the axis of the cylinder) or an ellipse if the plane intersects the axis of the cylinder at an angle alpha (a) larger than zero (i.e., other than a right angle) and other than 90 degrees.

The conventional coin wrapper 100 has the general form of a right circular cylinder wherein the edge 111 of its open receiving end 110 is a cylindrical section that is a circle. In the case of the conventional coin wrapper 100, the angle alpha (α) of the cylindrical section at the open end 110, is zero. Angle alpha (α) is measured relative the (“horizontal” as drawn) plane perpendicular to the geometrical (“vertical” as drawn) axis of the circular cylinder 200.

Thus, in the case of the conventional coin wrapper 100, a first height h₁ and any second (e.g., opposite) height h₂ of the circular cylinder 200 form of the conventional coin wrapper 100 have (substantially) equal values.

When a right circular cylinder 200 having a circular cylindrical section (e.g., the coin wrapper 100) is substantially compressed in a dimension perpendicular to its axis, it will take the form of a rectangle (e.g., the shape of Tubular Flat Paper Coin Wrappers).

FIG. 3 is a view of a conventional coin counting tube 300 having a tubular section 310 for holding a predetermined number (N) of coins 350 in a stack and a funnel portion 320 for receiving each one of the plurality (N) of coins 350. The funnel portion may be cone-shaped (having a circular perimeter) or it may have a funnel including one or more planar sides. The vendors of coin counting tubes 300 teach that the coin counting tube 300 is manually used as follows: “simply drop coins into tube” 300 until it holds the predetermined number (N) of coins; and then to “insert” a conventional paper coin wrapper (100 of FIG. 1) around the stack of coins 350; and then to “invert” the coin counting tube 300 in order to remove the stack of coins 350 held within the coin wrapper 100.

In use, a predetermined number (N) of coins 350 of a predetermined denomination (e.g., pennies, nickels, dimes, quarters, 50-cent pieces, and dollar coins) to be wrapped are inserted into the coin counting tube 300. It will be understood that the diameter (i.e., 2 times the radius r) and length of the coin counting tube 300 (and of the coin wrapper 100 to be inserted when it is filled) are predetermined determined according to the size (diameter and thickness) and number (N), respectively, of coins 350 to be packaged. The conventional coin wrapper 100 of FIG. 1 is to be inserted into the coin counting tube 300 around the plurality of coins 350 to be packaged.

Coin counting tubes having a smaller filling funnel (320), or no funnel, are mechanically filled by coin counting machines such as Ace Business Machines, Inc.'s Coin Counter & Wrapper Models CS-20 and 380/381 which are adapted to fill “coin tubes for the six US coin denominations”; and Jeil Coin Counter Co., Ltd.'s Electronic coin counter model JC-20A which is capable of filling coin tubes; and the Magner Model 915 “COIN COUNTER and COIN PACKAGER” sold by OfficeZone Inc.

When a conventional coin wrapper 100 (of FIG. 1) is inserted into a coin counting tube 300 containing a stack of (N) coins 350, it's insertion around the stack of (N) coins 350 is usually impeded by contact of the leading edge 111 of the tube 300 with one or more (horizontal) surfaces of coins in the stack 350 during insertion, which may prevent rapid insertion. The resistance presented by the stack of (N) coins 350 is generally due to the impact of the circular leading edge 111 of the conventional coin wrapper 100 with each of a series of stacked coins that are each in contact with a different vertical strip of the interior wall of the coin counting tube 300. Because the plurality (N) of coins in the stack of coins 350 are usually not deposited in a perfectly axially aligned stack atop each other and in axial alignment with the axis of the coin counting tube 300 (e.g., away from contact with the interior wall thereof, a random number (e.g., RN, where RN is greater than one) of the N coins in the stack 350 will generally be located in such a manner as to impede the rapid insertion of a conventional coin wrapper 100.

### SUMMARY OF THE INVENTION

A coin wrapper is provided that is adapted to being rapidly and facilely inserted into a coin-filled coin counting tube of the related art (e.g., 300 of FIG. 3).

According to an aspect of the present invention, there is provided a spade-pointed coin wrapper. The spade-pointed end of the coin wrapper may resemble the point of a new spade-pointed garden shovel, or the worn-down point of an old garden shovel.

Another aspect of the present invention provides a coin wrapper comprising: a tubular body (that is adapted to have a substantially circular cross-section when enclosing coins) and being adapted to enclose a plurality of stacked coins of a predetermined denomination; the coin wrapper has at least one receiving end, wherein the receiving end includes at least one protrusion (protruding in the direction parallel with the central axis of the tubular body).

Another aspect of the present invention provides a coin wrapper having an edge at a receiving end thereof, wherein the edge includes at least one angled portion adapted to facilitate the insertion of the receiving end of the coin wrapper into a coin-filled tube.

### BRIEF DESCRIPTION OF THE DRAWINGS

The preferred embodiments of the present invention will be described in detail with reference to the attached drawings in which:

FIG. 1 is an isometric view of a conventional coin wrapper having a sealed or crimped end and a receiving end having a substantially circular edge;

FIGS. 2A and 2B are diagrams illustrating the geometry of a circular cylinder 200 ending at a first (circular) cylindrical section at one end and ending at a second (elliptical) cylindrical section at the opposite end;

FIG. 3 is a view of a conventional coin-counting tube having an open end for the insertion of loose coins and the conventional coin wrapper of FIG. 1;

FIG. 4 is a diagram illustrating a first method whereby a (flattened) conventional coin wrapper of FIG. 1 can be transformed into a (flattened) coin wrapper in accordance with a first embodiment of the present invention;

FIG. 5A is a diagram depicting a (flattened) coin wrapper formed in accordance with a first embodiment of the present invention;

FIG. 5B is a diagram depicting a coin wrapper formed in accordance with a second embodiment of the present invention;

FIG. 6 is a diagram illustrating a method of rapid insertion of a coin wrapper formed according to the second embodiment of the present invention into the conventional coin-filled coin-counting tube of FIG. 3.

### DETAILED DESCRIPTION OF PREFERRED EMBODIMENTS

The present invention will now be described more fully with reference to the accompanying drawings, in which preferred embodiments of the invention are shown.

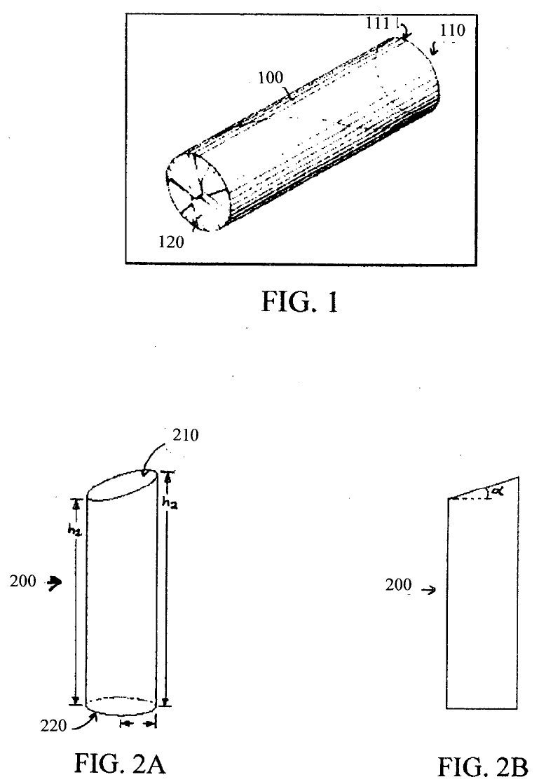

FIG. 4 is a diagram illustrating a first method whereby a (flattened) conventional coin wrapper 100 of FIG. 1 can be transformed into a (flattened) coin wrapper 500 (FIG. 5A) in accordance with a first embodiment of the present invention. A (flattened) conventional coin wrapper 100 of FIG. 1 is cut (e.g., by a blade or by scissors) along a line (e.g., a substantially straight diagonal line, as shown dotted in FIG. 4) at the receiving end 110 of the coin wrapper 100 to form a new (non-circular) edge at the receiving end 110 thereof. Thus the circular edge 111 of the conventional coin wrapper 100 is functionally replaced with an non-circular edge 511 of the coin wrapper 500 of FIG. 5A that has a new “spade point” 520 at its receiving end 510.

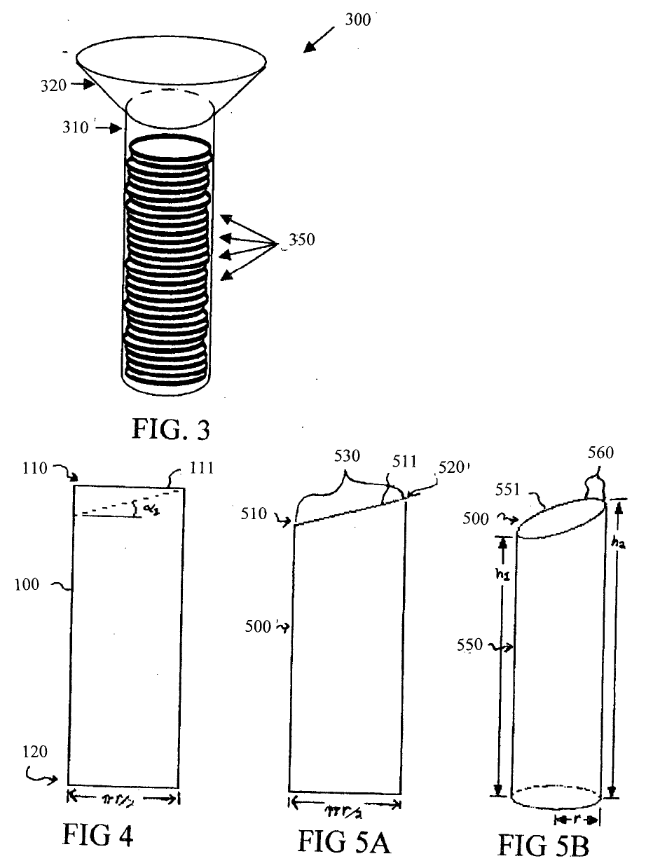

FIG. 5A is a diagram depicting a (flattened) coin wrapper formed in accordance with a first embodiment of the present invention. The “spade point” 520 and the angled portion 530 of the receiving edge 511 of the coin wrapper 500 facilitate the rapid insertion of the receiving end 510 of the coin wrapper 500 into a coin-filled coin-counting tube 300 (FIG. 3) of the related art. The “spade point” 520 minimizes the linear amount of the edge 511 of a coin wrapper 500 that can bluntly impact the horizontal surfaces of the coins 350 stacked inside the coin-counting tube 300 during insertion. This feature increases the probability that the coin wrapper 500 can be inserted into a coin-filled coin-counting without its leading (spade-pointed) edge 511 bluntly impacting with a horizontal surface of one or more (RN) of the plurality (N) of coins 350 stacked therein. If the coin-filled coin-counting tube is tipped or tapped so that all the stacked coins 350 are displaced into side-contact with the same (first) “vertical” strip portion of the interior wall of the coin-counting tube 300 (or are at least not in contact with the same (second, e.g., opposite) “vertical” strip portion of the interior wall of the coin-counting tube 300, the spade-pointed coin-wrapper 500 can be rapidly inserted down around the stacked coins 350 with a very small or even a zero probability that its insertion will be impeded by a blunt impact with a horizontal surface of any of the stacked coins 350. Accordingly, blunt impacts may be entirely avoided by the person who is inserting the disclosed spade-pointed coin wrapper 500 of the present invention for wrapping the coins 350 stacked within a coin-counting tube 300 (and by any machine or robot adapted to performing the same coin-wrapping task).

The relative movement of the angled portion 530 of the receiving edge 511 of the coin wrapper 500 during insertion tends to continuously push the plurality of coins 350 stacked inside the coin-counting tube 300 into axial alignment with each other (and away from the interior wall of the coin-counting tube 300 of FIG. 3) during insertion of the spade-pointed coin wrapper 500. Thus, the spade-pointed coin wrapper 500 may reduce or eliminate insertion-resistance presented by the plurality of coins 350 stacked inside the coin-counting tube (300 of FIG. 3). Persons skilled in the art of geometry will realize that in the case of a spade-pointed coin wrapper 500 formed by simply the cutting of a flattened tube (e.g., 100 of FIG. 4) on a straight “diagonal” cut-line (shown dotted in FIG. 4), the resulting spade-pointed coin wrapper 500 will not have a true elliptical edge at its receiving end 510. A true elliptical edge at its receiving end 510 of the resulting spade-pointed coin wrapper 500 is not necessary for the beneficial use of the inventive spade-pointed coin wrapper 500. The coin wrapper 500 may have a substantially (e.g., almost) elliptical edge 511 at its receiving edge 510.

In alternative embodiments of the invention, one receiving end 510 of the coin wrapper 500 may have a plurality (e.g., two or three) spade-points disposed around the edge 511 of the receiving end of the coin wrapper 500, and the term “spade-pointed coin wrapper” is intended to include any such variations that include at least one “spade point” at the of the receiving end of a coin wrapper. The term “point” is not limited to a singular point (maxima) nor to a sharp cusp disposed on the edge 511 of the receiving end 510 of a coin wrapper 500; rather the term “spade pointed” as used herein more generally includes the variety of curved or sharply pointed shapes which would resemble, to an ordinary person the “pointed” end of a garden shovel, including a new garden shovel and including a worn-down old garden shovel.

FIG. 5B is a diagram depicting a coin wrapper 550 formed in accordance with a second embodiment of the present invention. The coin wrapper 550 has a substantially elliptical edge 551. The coin wrapper 550 has a tubular body that is adapted to have a substantially circular cross-section and is adapted to enclose a plurality of stacked coins of a predetermined denomination. The tubular body has at least one receiving end 510, wherein the receiving end includes at least one protrusion 560. The protrusion 560 has a height of h₂ (measured from any circular section, e.g., at the other end, of the tubular body) whereas another (e.g., opposite) portion of the edge 551 of the receiving end 510 has a lesser height (h₁) (measured from the same circular section of the tubular body).

The height h₂ of the protrusion (point) 560 is greater than the base (first) height h₁ of the receiving end 510. The depth D (i.e., the difference between the heights h₁ and h₂) of the edge (511 or 551) at the receiving end (510 or 500) will generally be greater than zero and greater than the thickness T_{c} of a single one of the plurality of coins 350 of the predetermined denomination. The depth D (difference D=h₂ minus h₁) of the edge (511 or 551) of the receiving end in practical embodiments may range between one thickness T_{c} up to about 10 T_{c}. It is believed that depth D (h₂ minus h₁) needs to be greater than one thickness T_{c} of a single one of the plurality of coins 350 of the predetermined denomination in order for the advantages of the invention to be reliably practiced. Preferably, the depth D (difference h₂ minus h₁) will be between 2T_{c} and 8T_{c}. In practice, the depth D (difference of h₂ minus h₁) between 2T_{c} and 6T_{c} (e.g., between 3T_{c} and 5T_{c}) has been found to perform optimally for reliable rapid insertion of a coin wrapper 500 (or 550) that is sized for US Quarters (25 cent coins), into the conventional quarter-filled coin-counting tube 300 of FIG. 3.

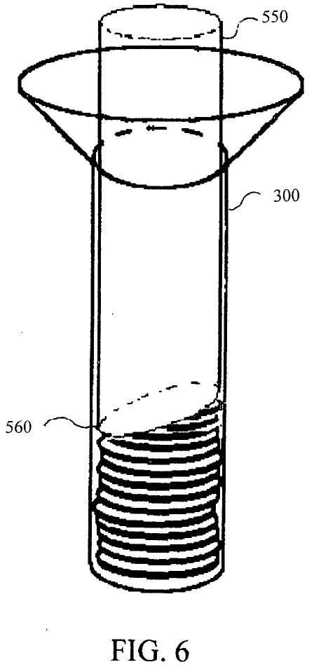

FIG. 6 is a diagram illustrating a method of rapid insertion of a coin wrapper 500 or 550, formed according to the first or second embodiment of the present invention, into the conventional coin-filled coin-counting tube 300 of FIG. 3.

As described above, a coin wrapper of the present invention can be rapidly and facilely inserted into a coin-filled tubular coin counting tube of the related art.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A spade-pointed coin wrapper.

2. The spade-pointed coin wrapper of claim 1 wherein the material of said wrapper is paper.

3. The spade-pointed coin wrapper of claim 1 wherein the material of said wrapper is plastic.

4. The spade-pointed coin wrapper of claim 1 wherein the spade point resembles the point of a new spade-pointed garden shovel.

5. The spade-pointed coin wrapper of claim 1 wherein the spade point resembles the worn-down point of an old garden shovel.

6. The spade-pointed coin wrapper of claim 1 sized to wrap coins of a predetermined denomination wherein the depth of the edge of the receiving end of the coin wrapper is greater than one thickness of one coin of the predetermined denomination.

7. The spade-pointed coin wrapper of claim 1 sized to wrap coins of a predetermined denomination wherein the depth of the edge of the receiving end of the coin wrapper is greater than one thickness of one coin of the predetermined denomination.

8. The spade-pointed coin wrapper of claim 1 sized to wrap coins of a predetermined denomination wherein the depth of the edge of the receiving end of the coin wrapper is greater than two thicknesses of one coin of the predetermined denomination.

9. The spade-pointed coin wrapper of claim 1 sized to wrap coins of a predetermined denomination wherein the predetermined denomination is selected from among pennies, nickels, dimes, quarters, 50-cent pieces, and US-dollar coins.

10. A coin wrapper comprising:
a tubular body that is adapted to have a substantially circular cross-section and being adapted to enclose a plurality of stacked coins of a predetermined denomination;
said coin wrapper having at least one receiving end, wherein the receiving end includes at least one protrusion in the direction of the central axis of the tubular body.

11. The coin wrapper of claim 10 wherein the material of said wrapper is paper.

12. The coin wrapper of claim 10 wherein the material of said wrapper is plastic.

13. The coin wrapper of claim 10 wherein the protrusion resembles the point of a spade-pointed garden shovel.

14. The coin wrapper of claim 10 wherein the depth of the protrusion is greater than one thickness of one coin of the predetermined denomination.

15. The coin wrapper of claim 10 wherein the depth of the protrusion is greater than two thicknesses of one coin of the predetermined; denomination.

16. The coin wrapper of claim 15 wherein the depth of the protrusion is greater than two thicknesses of one coin of the predetermined denomination and is less than six thicknesses of one coin of the predetermined denomination.

17. The coin wrapper of claim 16 wherein the predetermined denomination is selected from among pennies, nickels, dimes, quarters, 50-cent pieces, and US-dollar coins.

18. The coin wrapper of claim 16 wherein the predetermined denomination quarters.

19. The coin wrapper of claim 10 wherein the predetermined denomination is selected from among pennies, nickels, dimes, quarters, 50-cent pieces, and US-dollar coins.

20. A tubular coin wrapper having an edge at a receiving end thereof, wherein the edge includes at least one angled portion adapted to facilitate the insertion of the receiving end of the coin wrapper into a coin-filled tube.
